(19) United States
(12) Patent Application Publication
(10) Pub. No.: US 2007/0031805 A1
(43) Pub. Date: Feb. 8, 2007

(54) Method and system for digital training with internet video advertising

(75) Inventor: Aerock Fox, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Monarch Software Inc., West Vancouver (CA)

(21) Appl. No.: 11/393,919

(22) Filed: Mar. 31, 2006

Related U.S. Application Data
(60) Provisional application No. 60/666,584, filed on Mar. 31, 2005.

(51) Int. Cl. G09B 3/00

(52) U.S. Cl. 434/350; 434/362

(57) ABSTRACT

A method of using the Internet to facilitate training of students which permits students to learn skills and be critiqued on those skills by others, including skilled trainers, without being in the same physical location, by providing an Internet website which permits uploading and downloading of video files to both instruct the student and permit critique of the students' skills by others.

### CROSS-REFERENCE TO RELATED APPLICATION

This application claims priority from U.S. Provisional Patent Application Ser. No. 60/666,584 filed Mar. 31, 2005, which is pending.

### TECHNICAL FIELD

The invention relates to methods of training, and particularly methods of training using video tapes.

### BACKGROUND

Traditionally, people who are interested in getting help in their career field or even with a hobby, such as golf, will purchase books, hire local professionals, and/or buy training videos and DVD's online. Using the traditional methods, people may read a book or watch video tapes hoping that by the time they are done they will have mastered something in the area they are learning. In the case of a person reading a book, there is no feedback unless the person actively seeks it out, and it is up to the reader to interpret what is being taught. In the case of a video, the video watcher can see the technique done. However like the book reader, they must seek out feedback on their technique, otherwise they may never know if it is flawed.

One of the most effective ways to learn is one on one teaching, where a teacher can guide and correct the student immediately, before improper technique becomes a permanent problem. This method can be costly in both money and time and retention of information is related to the length of time or the amount of information in a session. Furthermore, the quality of available teachers can be limited by a person's geographic location. For example, someone who wishes to be a good golfer but has no golf pros in that person's geographic area has limited choices for high level of instruction. There is therefore a need for a method to permit students to learn targeted specific skills quickly and accurately and be critiqued on that skill by others, including skilled trainers, without being in the same physical location.

Also, currently when sponsors want to advertise on the Internet, they buy banner ads or pop up windows. Current browser technology can block this form of advertising. With the advancement of broadband technology, advertisers are looking for new ways to reach their consumers other than traditional television.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The present invention provides a system method of using the Internet to permit a plurality of users, each having a computer with a web browser accessible to the Internet, to obtain video training information and feedback on skill development from trainers or other users, each having a computer with a web browser accessible to the Internet, the method comprising:
i) providing a web site maintained by a server accessible over the Internet to the plurality of users, trainers and other users, the web site adapted to permit users to selectively access a plurality of sub-sites each directed to a specific training subject matter;
ii) permitting a user to download from the web site to the user's computer one or more training video files;
iii) permitting a user to periodically upload video files to the web site for review by trainers or other users; and
iv) providing means for the users to select and engage trainers appropriate for training in the specific training subject matter and providing the feedback.

In addition to the exemplary aspects and embodiments described above, further aspects and embodiments will become apparent by reference to the drawings and by study of the following detailed descriptions.

### BRIEF DESCRIPTION OF DRAWINGS

Exemplary embodiments are illustrated in referenced figures of the drawings. It is intended that the embodiments and figures disclosed herein are to be considered illustrative rather than restrictive.

FIG. 1 is a Flow Chart illustrating the method of the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

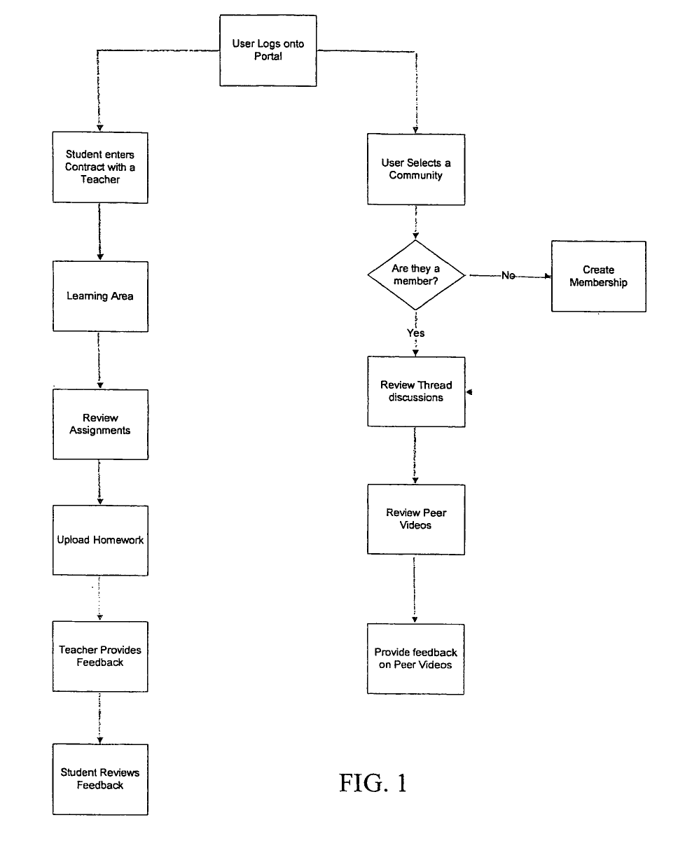

With reference to FIG. 1, a User logs on to the system's Internet portal from an Internet-accessible terminal and registers for the system, if not already a Member, by creating an account, entering in basic information to get himself/herself started, such as username, full name, geographic location and contact email. The User then selects one or more Communities to join by browsing the Communities that interest him or her, for example Golf and Fishing, and selects the Communities which the user wishes to join. There is no limit to the number of Communities a User can join.

Once a User has joined a Community and has become a Member of that Community, he/she can go to a Manage Communities area of the web site that will allow him or her to set his/her skill level (Beginner, Intermediate, or Advanced), and provide an email address for the “ePitch(s)” as described below. The User can also purchase video files (“packages”) for uploading or downloading from this area as well. Packages can be purchased across Communities, so if the User pays to upload three videos, he/she can upload all three to one Community or one to three different Communities. The User can also elect to be notified of changes to each Community, such as when feedback is uploaded or when new videos are added.

Once the User enters a Community as a Member, within each Community section of the site, the User can review thread discussions, review peer videos, provide feedback on peer videos, and browse through the different training courses available or Trainers for sale. The User can click on the course name to see more details, such as pre-requisites for the course. If the User chooses to participate, he/she then follows the sign-up instructions which can differ from course to course. If a Teacher or Trainer is full, the Member can sign up to be on the waiting list to be notified when an opening becomes available.

Once a User signs up for a course, he/she can go to his or her learning area which will provide access to all the courses the User is currently taking or have taken in the past, regardless of Communities. For example, a Student could be taking a language course and a golfing course at the same time, but he/she would go to one learning area to get his/her assignments and feedback from each Teacher or Trainer. In each Community, the User can go to a Member area that will allow them to review any discussions, review uploaded video and if requested, provide feedback on an uploaded video. If there is feedback presented, a flag will be displayed for the user to review. There will also be comments and other information regarding the video. The User can also click on the owner of the video to learn more about the other users. If a member has notification watches, when the User enters the Member area of the Community he or she will see a list of the watches.

A User can go to his or her personal area, which will allow the User to review his or her personal information, and the User can create a “public” profile, viewable by other Members of the Community, so other members can learn more about him/her. The User can then also manage in the personal area any videos that have been uploaded, and see feedback that was given to the videos by peers or Teachers. The User can also review videos side by side to see how he or she is progressing. From the personal area the User can also manage his/her Communities.

The User may download or view a lesson video or training video. The User may then video record himself/herself doing what the assignment calls for. It may be an imitation of what he/she sees on the training video or even a specific assignment given by the Trainer. Or the User may just record himself/herself performing an action on which he/she would like feedback that will be posted to the Community. Using a codec, encoding settings and uploader, the User may upload the video file for the Trainer to review, or upload it to a Members' area of a Community. Feedback may be given by the Trainer or other Members, which the User can review from their personal area.

If a User is looking for a Trainer or a course, the System allows the User to search or browse from a list of available Trainers in that Community. The System may also suggest or recommend Trainers based on the information the Users provide about themselves and the Student Criteria dictated by the Trainer. The System may send out a mass ePitch to the Members with a special training tip (their “Featured Tips”). This can be on a frequency such as bi-Monthly or when the Content Manager chooses. The mass mailing is in the form of an email, or if the User elects they can use an RSS feed to have the information that is contained in the email displayed to a mobile device, with a link to the actual Featured Tip. A Featured Tip may have a 30 second clip from the sponsor before the actual tip. Featured Tips may be tracked for reporting purposes so the Sponsor can review how successful the Tip was in attracting new customers. The data may be stored in a relational database such as SQL, with the physical media stored on the file system. A Third Party Portal, such as Microsoft Share Point Portal Server could be used to provide the base infrastructure for the application along with additional functionality. The System may also provide search capabilities within each Community.

The Invention thus provides a method for individuals [Members] to join a Community of peers, which provides them access to various levels of Trainers [Teachers]. For example, the Trainer level can range from country club golf pro to a national celebrity golfer. The Members can be peers at various skill levels. Bi-monthly tips can be delivered to their email. The Invention also allows for a Student to network and find others in different geographic locations to share experiences with, get advice from and create relationships. The Invention can also help match Members with Teachers based on a variety of criteria, such as the Member's level (Beginner, Intermediate, and Advanced), interest level, or even geographic location. The Invention also provides a way for people and companies to cross-promote and increase brand loyalty. For example, if a national sneaker company becomes linked to a series of training videos in a specific community, a successful Member may associate his or her success with that national sneaker company and become a loyal supporter. The Invention can be applied to any type of industry, so the Invention can have many different communities, for example: Sports, Cooking, Fly Fishing, General Hobbies, Music, Education, Acting, Languages. Furthermore, the Invention can be licensed to a specific company or business, for example a sports magazine, to be used solely with their content and creating Communities of their customers.

The Invention provides a place for Members to have a personal database. In the personal database, the Members can store information about themselves that can be both public and private. They can also store personal profiles which could contain statistical information such as batting averages or golf scores. Furthermore, the Members may each have an online library of videos they have uploaded, and a history of feedback, either from a Teacher or from a Peer group which they could review at any time. Because the Invention works with video technology, over time the Member can view the uploaded videos to see how he or she is progressing, plus the Member can compare different videos, side by side to see the differences as he or she improves, such as a before and after video. This exchange is a two-way collaborative exchange. Each Community has a public area that can be co-branded or sponsored by an Advertiser. This area is accessible to a Community Member. The public area of a Community allows those Members interested in the subject of the Community to review, receive and provide feedback. By having the Members join a Community, the Invention allows for advertisers to learn more about their customers and get information on them that can be used for marketing purposes.

Members who belong to a Community may be “epitched” (a method of internet delivery of customized information packages, as disclosed in co-pending U.S. provisional patent application No. 60/560,595 filed Apr. 9, 2004, which is incorporated herein by reference) information videos by advertisers, such as a Featured Tip. The frequency of the ePitch can be pre-set, for example bimonthly. The content can be customized to the Members' skill level, or they can be ePitched tips at all skill levels. A Member has the ability to forward the tip video or their own video to a friend for review and feedback. The ePitch contains a link to a video designated as the Featured Tip. The Featured Tip clip has advertisements from the sponsor and is freely downloadable from the Invention. The ePitched Tips can be geared to the skill level of the Student. For example, a beginning golfer may see a tip on how to improve one's grip, while a more advanced golfer would see more specifics on judging a shot or getting out a sand trap. Each Community has a Content Manager that creates and manages the Featured Tip Videos, and creates and distributes material through ePitch, and manages the frequency of the ePitch. The ePitched Feature Tip can also contain advertisements for several sponsors. The Tips can be created by the Content Managers either by shooting and editing the video, or through a partnership, where content is given to them and then edited to be two to three minutes in length.

Another option is for the Members to download a client software application to their computer, that would at a specific intervals retrieve the video clips and download them to the Member's hard drive so they can be viewed off line. Using RSS (“Really Simple Syndication”) Feed Technology, a Member can program his or her mobile device to receive notification of new tips at any time, instead of waiting for the bimonthly ePitch, and, if the device is capable, view the video clip through their device.

A Member has three ways of getting feedback for their training: 1) They can enter into a contractual agreement with a Teacher; 2) Allow a specific peer group to give feedback, such as a group of friends; or 3) Allow anyone in the community, at any skill level, to provide feedback. If the Member enters into a contractual agreement with a Teacher, the Member is committed to following the guidelines set out by the Teacher. A Teacher can have assignments and the Member would then complete the assignments. The time to complete the assignments is determined between the user and teacher and could be defined as a few days, or it could be as long as the Member wishes to take to complete the assignment.

An example of an assignment would generally be for the Member to provide the Teacher a video tape or an audio tape, or even a document, which is then uploaded for the Teacher to review and provide feedback. Furthermore, there would also be a financial arrangement made between the Member and the Teacher that would have been met prior to starting the course. The Member would pay for the course online using a built-in E-Commerce System. Thus when a Member has a contractual agreement with a Teacher, the Member will be asked to pre-pay for the course when he/she signs up. The course length is defined by the Teacher. It could be defined in time (e.g. weeks) or it can be the number of times a Student can ask for Feedback (e.g. three times). By using video, the Invention emphasizes the use of visualization as a key component to learning. The Invention also allows for a Teacher to set up their course, and pre-assign a number of lessons or assignments to be given at a specific interval or pre-packaged as a student passes each level. For example, a Teacher can set up a set of assignments for a language course. Once a Member has completed lesson one, the Invention would automatically provide lesson two and so forth. Or the Teacher can manually assign the next lesson to the Member when the Teacher is satisfied the member has learned what is required in the previous lesson. A Teacher can obtain information on when and how many times their lesson video has been seen by a particular Member. In this way, Teachers can instantly monitor the student's progress.

The Invention also allows a Teacher to gain information about a Member at the time of sign-up, to help the Teacher know more about the Members. Also the Invention allows a Teacher to limit the number of members for a particular course or over time. The Invention also allows the Member to sign up for a waiting list so that when a spot becomes available, the Invention will notify the Member. The Invention also allows for live lectures, so at a specific time, a number of Members can log in to the system's web site, and watch live demonstrations by a Teacher on-line by way of a webcast. The Members can also ask questions, which the Teacher can answer in real time. The Invention allows for the Teacher to review the assignments online, from anywhere in the world, and provide feedback at any time.

The other ways to receive feedback are from a select peer group or from the entire Community. The Member would select the peer group and then share the video with them, inviting them to provide feedback and to discuss the video that was uploaded. For example, a coach of a hockey team may have all his Members sign up, form them into a network of friends and then have each of them upload a video for analysis, each of them providing feedback. This method allows for privacy of the video content, because only the peer group of friends can see it, plus it allows for collaboration between the peers. The final method for feedback is getting it from the whole Community. As a member of the Community, the Member can upload a video, and other Members can post their comments. This method provides the Member with the potential for the most feedback.

The Invention can use any available e-commerce payment options for allowing Members to pay for uploaded training videos. Membership to Communities may be paid on an annualized or monthly basis, to cover the cost of bandwidth and storage. The Featured Tips may be free and paid by the sponsors. If the Member has a contractual agreement with a Teacher, there would normally be an additional fee paid by the Member to the Teacher. The Community may act as an agent and acquire an agent fee for the Member/Teacher contract. The Featured Tip Video may generate revenue by sponsorships. An Advertiser can purchase spots for a setup fee and on a pay per view basis.

The Invention also provides a way for advertisers to gather information needed for their marketing campaigns. This can be done at the time a Member signs up or at the time they join a Community or even periodically when they log in. The Invention also allows for Administrator, apart from Content Managers to handle any issues between the Student and the Teacher, deal with payment problems, and to monitor feedback. The Invention may also track each tip as it is sent out in the ePitch for response, and whether it was read or viewed. All the tracking information may be made available to the Sponsor so they can see how successful a tip was in attracting new customers.

The invention further provides an Internet Website System which combines the foregoing method of internet video skill training with the application of online marketing and promotion of internet video advertising. The internet video skill training facilitates the matching and management of students, teachers, mentors and coaches, from beginners to professionals on a global basis while teaching a specific skill. The online marketing and promotion of internet video advertising takes skills or training tips and distributes them to users in a specific demographic supported by corporate sponsors or manufacturers on a pay per view or flat rate basis assisting the sponsor or manufacturer in creating brand awareness and brand loyalty. By using video technology over the internet, this allows advertisers to get their product closer to their consumers. Spots can easily be edited into the videos that are free and downloadable from the web.

The present invention permits students to learn skills and be critiqued on those skills by others, including skilled trainers, without being in the same physical location, by providing an Internet website which permits uploading and downloading of video files to both instruct the student and permit critique of the students' skills by others. Short videos will allow a person to perform immediately the technique they have just viewed while the information is fresh in their mind. After viewing it, they can then upload their version of the video to a portal where it can be reviewed by a professional, and the student is then provided with instant feedback as if they were working one-on-one.

The invention further provides an Internet Website System which combines the foregoing method of internet video skill training with the application of online marketing and promotion of internet video advertising. The internet video skill training facilitates the matching and management of students, teachers, mentors and coaches, from beginners to professionals on a global basis while teaching a specific skill. The online marketing and promotion of internet video advertising takes skills or training tips and distributes them to users in a specific demographic supported by corporate sponsors or manufacturers on a pay per view or flat rate basis assisting the sponsor or manufacturer in creating brand awareness and brand loyalty.

The invention thus provides generally a method to allow students to get training and instant feedback on video they have uploaded to a specific site, which may involve working one-on-one with an industry-specific professional, permits teachers to track student progress and create course curriculum online, and manage course materials online, create assignments, and deliver live lecture series. It permits students to receive and provide peer feedback, match students and teachers and match hobbyists and professionals, It further includes as aspects of the method means for facilitating Internet Video Advertising (Featured Tips), online marketing, managing the frequency of the online marketing, creating and maintaining brand loyalty and brand awareness, a means for advertisers to gather personal information on a customer, and distribute advertising information electronically,

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method of using the Internet to permit a plurality of users, each having a computer with a web browser accessible to the Internet, to obtain video training information and feedback on skill development from trainers or other users, each having a computer with a web browser accessible to the Internet, the method comprising:
i) providing a web site maintained by a server accessible over the Internet to said plurality of users, trainers and other users, said web site adapted to permit users to selectively access a plurality of sub-sites each directed to a specific training subject matter;
ii) permitting a user to download from said web site to said user's computer one or more training video files;
iii) permitting a user to periodically upload video files to said web site for review by trainers or other users;
iv) providing means for said users to select and engage trainers appropriate for training in said specific training subject matter and providing said feedback.

2. The method of claim 1 wherein said web site permits said trainers to communicate with and provide feedback to said users.

3. The method of claim 1 wherein said web site permits users to communicate with and provide feedback to other users.

4. The method of claim 1 wherein said web site permits users to review and provide feedback on other users' videos by accessing said sub-site.

5. The method of claim 1 wherein said web site permits users to select and enroll in training courses by accessing said sub-site.

6. The method of claim 1 wherein said web site permits users to be waitlisted for enrollment in a selected training courses by accessing said sub-site and be notified by electronic mail when an opening becomes available.

7. The method of claim 1 wherein said web site permits users to identify a skill level to be associated with said user within said sub-site.

8. The method of claim 1 wherein said web site permits users to select whether said uploaded video will be accessible for review by all other users or a limited selection of other users.

9. The method of claim 1 wherein said web site permits users to view live online training webcasts provided by said trainers.

10. The method of claim 1 wherein said web site permits users to upload assignment files for review by said trainers online.

11. The method of claim 1 wherein said web site permits trainers to provide course curriculum to users for downloading.

12. The method of claim 1 wherein said web site permits advertisers to periodically distribute advertising information electronically to selected groups of users.

13. The method of claim 12 wherein said web site permits advertisers to gather personal information concerning users for marketing purposes.

14. The method of claim 12 advertising information is included with training information specific to said skill development.

15. A system for using the Internet to permit a plurality of users, each having a computer with a web browser accessible to the Internet, to obtain video training information and feedback on skill development from trainers or other users, each having a computer with a web browser accessible to the Internet, the system comprising:
i) a plurality of users' computers each having a web browser accessible to the Internet;
ii) a plurality of trainers' computers each having a web browser accessible to the Internet;
iii) a web site maintained by a server accessible over the Internet to said plurality of users and trainers, said web site adapted to:
a) permit users to selectively access a plurality of sub-sites each directed to a specific training subject matter;
b) permit a user to download from said web site to said user's computer one or more training video files;
c) permit a user to periodically upload video files to said web site for review by trainers or other users; and
d) provide means for said users to select and engage trainers appropriate for training in said specific training subject matter and providing said feedback.
